(19) United States
(12) Patent Application Publication
(10) Pub. No.: US 2017/0045268 A1
(43) Pub. Date: Feb. 16, 2017

(54) ELECTRIC MOTOR, HERMETIC COMPRESSOR, AND REFRIGERATION CYCLE APPARATUS

(71) Applicant: Mitsubishi Electric Corporation, Tokyo (JP)

(72) Inventor: Yoshikazu FUJISUE, Tokyo (JP)

(21) Appl. No.: 15/304,661

(22) PCT Filed: Mar. 12, 2015
(86) PCT No.: PCT/JP2015/057369

§ 371 Date: Oct. 17, 2016

(30) Foreign Application Priority Data
Apr. 30, 2014 (JP) 2014-093356

(51) Int. Cl. F25B 1/04; H02K 7/14; H02K 3/18; F04C 29/00; H02K 3/02

(52) U.S. Cl. CPC F25B 1/04; F04C 29/0085; H02K 3/02; H02K 3/18; H02K 7/14

(57) ABSTRACT

An electric motor including: a stator having a cylindrical shape and including a stator core and a stator winding wound around the stator core; and a rotor rotatably disposed inside the stator, the stator winding includes a plurality of windings connected in series in each phase, the plurality of windings in each phase are constituted by both copper wire and aluminum wire, and a ratio between the aluminum wire and the copper wire is uniform among phases.

### TECHNICAL FIELD

The present invention relates to an electric motor including a stator winding using conductors of different materials, a hermetic compressor equipped with the electric motor, and a refrigeration cycle apparatus including a hermetic compressor.

### BACKGROUND ART

A conventional electric motor includes stator windings constituted by conductors of both copper and aluminum (see, for example, Patent Literature 1). Patent Literature 1 has a purpose of reducing weight of the electric motor and enhancing corrosion protection against wetting by increasing the ratio of the aluminum conductor in the entire stator windings as high as possible (with 3 to 9% of copper in terms of number of the stator windings).

### CITATION LIST

### Patent Literature

Patent Literature 1: Japanese Unexamined Patent Application Publication No. 2007-20302 (claims)

### SUMMARY OF INVENTION

### Technical Problem

Copper and aluminum have different electrical resistivities (copper: 16.78 [Ω·m], aluminum: 28.2 [Ω·m]). Thus, when the ratio between copper and aluminum differs among phases, phase resistance differs among the phases so that current unbalance occurs among the phases. This current unbalance causes torque pulsation of the electric motor, resulting in an increase in occurrence of electromagnetic sound. In addition, since the aluminum has an electrical resistivity higher than that of copper, a loss of Joule's heat generated in the stator windings of aluminum increases so that the efficiency of the electric motor might decrease.

The present invention has been made to solve problems as described above. A first object of the present invention is to provide a cost-effective low-noise electric motor using both copper wire and aluminum wire while suppressing a decrease in efficiency.

A second object of the present invention is to enhance productivity and quality of the electric motor including stator windings using both the copper wire and the aluminum wire.

A third object of the present invention is to provide a high-quality, cost-effective, and low-noise hermetic compressor having a predetermined efficiency.

A fourth object of the present invention is to provide a highly reliable refrigeration cycle apparatus.

### Solution to Problem

An aspect of the present invention provides an electric motor including a stator having a cylindrical shape and including a stator core and a stator winding wound around the stator core; and a rotor rotatably disposed inside the stator. The stator winding includes a plurality of windings connected in series in each phase, and the plurality of windings in each phase are constituted by both copper wire and aluminum wire, and a ratio between the aluminum wire and the copper wire is uniform among phases.

### Advantageous Effects of Invention

According to the aspect of the present invention, the windings of the stator winding in each phase are constituted by both the copper wire and the aluminum wire, and the ratio between the windings of the aluminum wire and the windings of the copper wire is uniform among the phases. With this configuration, the resistance of windings is uniform among the phases, and accordingly, the balanced current flows through each phase. Thus, generation of torque pulsation of the electric motor can be reduced, while suppressing a decrease in efficiency of the electric motor. Thus, a high-quality, cost-effective, and low-noise electric motor using both the aluminum wire and the copper wire can be provided.

### BRIEF DESCRIPTION OF DRAWINGS

FIG. 1 is a longitudinal cross-sectional view schematically illustrating an example configuration of a hermetic compressor according to Embodiment 1.

FIG. 2 is a transverse cross-sectional view illustrating a compression mechanism of the hermetic compressor taken along a line A-A in FIG. 1.

FIG. 3 is a diagram schematically illustrating a configuration of a refrigeration cycle apparatus including the hermetic compressor illustrated in FIG. 1.

FIG. 4 is a transverse cross-sectional view of an electric motor taken along a line B-B in the hermetic compressor in FIG. 1.

FIG. 5 is a top view schematically illustrating stator windings of an electric motor of the hermetic compressor according to Embodiment 1.

FIG. 6 is a connecting diagram of stator windings of the electric motor illustrated in FIG. 5.

FIG. 7 is a connecting diagram of stator windings of an electric motor according to Embodiment 2.

### DESCRIPTION OF EMBODIMENTS

### Embodiment 1

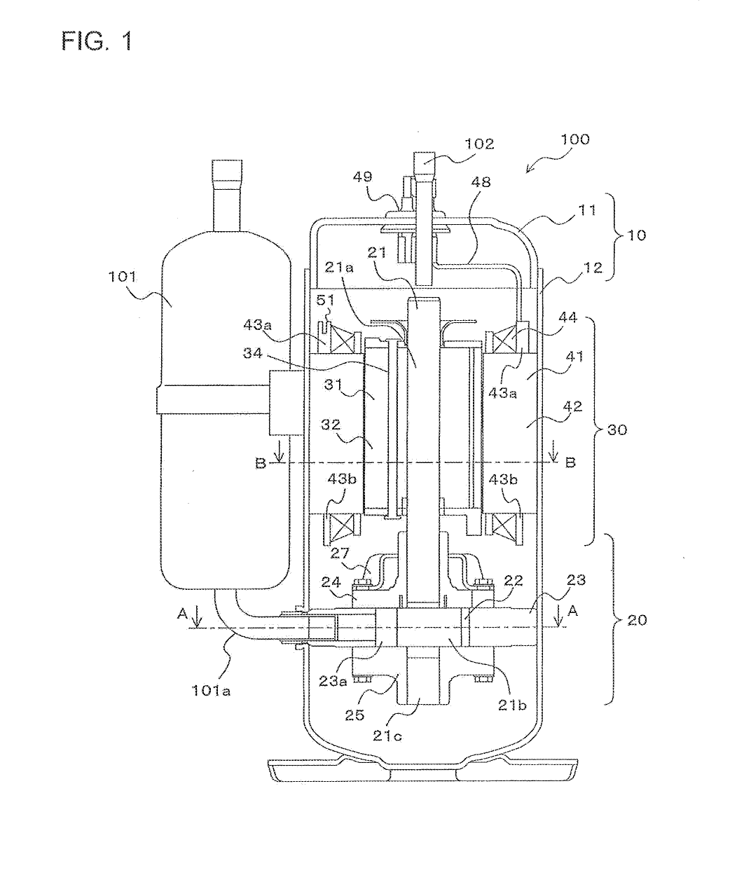

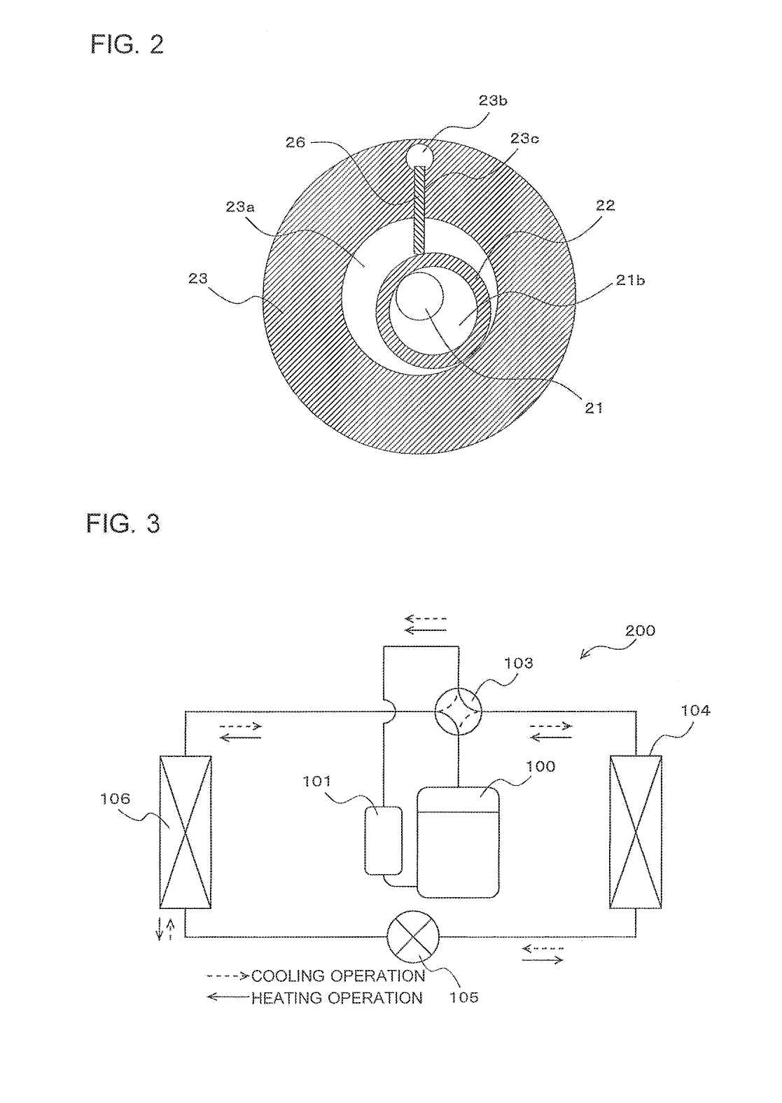

FIG. 1 is a longitudinal cross-sectional view schematically illustrating an example configuration of a hermetic compressor according to Embodiment 1 of the present invention. FIG. 2 is a transverse cross-sectional view illustrating a compression mechanism of the hermetic compressor taken along a line A-A in FIG. 1.

The hermetic compressor 100 illustrated in FIG. 1 is, for example, a cylinder rotary compressor including a hermetic container 10, a compression mechanism 20 for compressing refrigerant gas in the hermetic container 10, and an electric motor 30 for driving the compression mechanism 20.

The hermetic container 10 includes a bottomed cylindrical lower container 12 and an upper container 11 hermetically covering an upper opening of the lower container 12. The compression mechanism 20 is disposed in lower space of the lower container 12, and the electric motor 30 is disposed in upper space of the lower container 12. The compression mechanism 20 is coupled to the electric motor 30 by a rotation shaft 21 of the electric motor 30 so that rotational motion of the electric motor 30 is transmitted to the compression mechanism 20. Using the transmitted rotation force, the compression mechanism 20 compresses refrigerant gas, and discharges the gas into the hermetic container 10. That is, the hermetic container 10 is filled with the compressed high-temperature high-pressure refrigerant gas. In lower space of the hermetic container 10, that is, in a bottom portion of the lower container 12, refrigerating machine oil for lubricating the compression mechanism 20 is stored.

An oil pump is provided at a lower portion of the rotation shaft 21. This oil pump pumps the refrigerating machine oil stored in the bottom portion of the hermetic container 10 by using rotation of the rotation shaft 21, and supplies the oil to sliding portions of the compression mechanism 20. In this manner, mechanical lubrication effect of the compression mechanism 20 is obtained.

The rotation shaft 21 includes a main shaft portion 21a, an eccentric shaft portion 21b, and a sub-shaft portion 21c. The main shaft portion 21a, the eccentric shaft portion 21b, and the sub-shaft portion 21c are arranged in this order along the axis of the rotation shaft 21. A rotor 31 of the electric motor 30 is fixed to the main shaft portion 21a by shrinkage fitting or press fitting. A cylindrical rolling piston 22 is fitted into the eccentric shaft portion 21b.

A configuration of the compression mechanism 20 will now be described with reference to FIG. 2.

FIG. 2 is a transverse cross-sectional view illustrating the compression mechanism of the hermetic compressor taken along a line A-A in FIG. 1.

The compression mechanism 20 includes a cylinder 23, the rolling piston 22, an upper bearing 24, a lower bearing 25, and a bane 26. The cylinder 23 has a cylindrical shape in which an axially formed hole is used as a cylinder chamber 23a. The cylinder chamber 23a houses the eccentric shaft portion 21b that performs eccentric motion in the cylinder chamber 23a, the rolling piston 22 fitted into the eccentric shaft portion 21b, and the bane 26 partitioning space formed by an inner periphery of the cylinder chamber 23a and an outer periphery of the rolling piston 22.

The cylinder 23 has a bane groove 23c whose one end is open to the cylinder chamber 23a and the other end is provided with a back-pressure chamber 23b. The bane groove 23c houses the bane 26. The bane 26 reciprocates radially in the bane groove 23c. The bane 26, which is housed in the bane groove 23c, has a substantially cuboid shape in which the thickness of the bane 26 along the circumferential direction of the cylinder chamber 23a is smaller than each of the length of the bane 26 in a radial direction and an axial direction of the cylinder chamber 23a. The back-pressure chamber 23b of the bane groove 23c includes an unillustrated bane spring.

In general, high-temperature refrigerant gas in the hermetic container 10 flows into the back-pressure chamber 23b so that a force that radially moves the bane 26 toward the center of the cylinder chamber 23a is generated by a differential pressure between a pressure of refrigerant gas in the back-pressure chamber 23b and a pressure of refrigerant in the cylinder chamber 23a. The bane 26 is radially moved toward the center of the cylinder chamber 23a by the force generated by the differential pressure between the back-pressure chamber 23b and the cylinder chamber 23a and a force that radially presses the bane 26 by the bane spring. The force that radially moves the bane 26 brings an end of the bane 26, that is, an end of the bane 26 near the cylinder chamber 23a, into contact with an outer periphery of the rolling piston 22.

In this manner, the space formed by the inner periphery of the cylinder 23 and the outer periphery of the rolling piston 22 is partitioned. Even in a case in which the differential pressure between the pressure of refrigerant gas in the hermetic container 10, that is, refrigerant gas in the back-pressure chamber 23b, and the pressure of refrigerant gas in the cylinder chamber 23a is not sufficient for pressing the bane 26 against the outer periphery of the rolling piston 22, an end of the bane 26 can be pressed against the outer periphery of the rolling piston 22 by a force of the bane spring, and thus, the end of the bane 26 can always be in contact with the outer periphery of the rolling piston 22.

The upper bearing 24 has a substantially inverted T-shape in a side view, covers an upper opening of the cylinder chamber 23a, and rotatably supports the main shaft portion 21a of the rotation shaft 21. The lower bearing 25 has a substantially T-shape in a side view, covers a lower opening of the cylinder chamber 23a, and rotatably supports the sub-shaft portion 21c of the rotation shaft 21. The cylinder 23 has a suction port through which refrigerant gas is sucked into the cylinder chamber 23a from the outside of the hermetic container 10. The upper bearing 24 has a discharge port through which compressed refrigerant gas is discharged to the outside of the cylinder chamber 23a.

A discharge valve is provided at the discharge port of the upper bearing 24, and controls the timing of discharging high-temperature high-pressure refrigerant gas from the cylinder 23 through the discharge port. That is, the discharge valve is closed until refrigerant gas compressed in the cylinder chamber 23a of the cylinder 23 reaches a predetermined pressure, and when the refrigerant gas reaches the predetermined pressure or more, the discharge valve is opened so that the high-temperature high-pressure refrigerant gas is discharged to the outside of the cylinder chamber 23a.

Since operations of suction, compression, and discharge are repeatedly performed in the cylinder chamber 23a, refrigerant gas is intermittently discharged from the discharge port, which causes noise such as pulsing noise. To reduce such noise, a discharge muffler 27 is attached to the outer side of the upper bearing 24, that is, the side of the upper bearing 24 facing the electric motor 30, and covers the upper bearing 24. The discharge muffler 27 has a discharge hole that allows space formed by the discharge muffler 27 and the upper bearing 24 and the space in the hermetic container 10 to communicate with each other. Refrigerant gas discharged from the cylinder 23 through the discharge port is temporarily discharged to the space formed by the discharge muffler 27 and the upper bearing 24, and then is discharged into the hermetic container 10 through the discharge hole.

A suction muffler 101 for restricting suction of liquid refrigerant directly into the cylinder chamber 23a of the cylinder 23 is provided at the side of the hermetic container 10. In general, the hermetic compressor 100 receives a mixture of low-pressure refrigerant gas and liquid refrigerant from an external circuit to which the hermetic compressor 100 is connected. When the liquid refrigerant flows into the cylinder 23 and compressed in the compression mechanism 20, the compression mechanism 20 might be damaged. Thus, liquid refrigerant and refrigerant gas are separated in the suction muffler 101 so that only the refrigerant gas is sent to the cylinder chamber 23a. The suction muffler 101 is connected to a suction port of the cylinder 23 through a connecting pipe for suction 101a, and the low-pressure refrigerant gas sent from the suction muffler 101 is sucked into the cylinder chamber 23a through the connecting pipe for suction 101a.

In the thus-configured compression mechanism 20, rotational motion of the rotation shaft 21 causes the eccentric shaft portion 21b of the rotation shaft 21 to rotate in the cylinder chamber 23a of the cylinder 23. The volume of the actuation chamber defined by the inner periphery of the cylinder chamber 23a, the outer periphery of the rolling piston 22 fitted in the eccentric shaft portion 21b, and the bane 26 increases or decreases in accordance with rotation of the rotation shaft 21. First, the actuation chamber communicates with the suction port so that low-pressure refrigerant gas is sucked. Then, the communication between the actuation chamber and the suction port is closed, and as the volume of the actuation chamber decreases, the refrigerant in the actuation chamber is compressed. Lastly, the actuation chamber communicates with the discharge port, and after refrigerant gas in the actuation chamber has reached a predetermined pressure, the discharge valve provided at the discharge port is opened, and high-pressure high-temperature refrigerant gas is discharged to the outside of the actuation chamber, that is, the outside of the cylinder chamber 23a.

The high-pressure high-temperature refrigerant gas discharged from the cylinder chamber 23a into the hermetic container 10 through the discharge muffler 27, passes through the electric motor 30, rises in the hermetic container 10, and is discharged from the discharge pipe 102 provided in the upper portion of the hermetic container 10 to the outside of the hermetic container 10. A refrigeration cycle in which refrigerant flows is provided outside the hermetic container 10, and discharged refrigerant circulates in the refrigeration cycle and returns to the suction muffler 101 again.

FIG. 3 is a diagram schematically illustrating a configuration of a refrigeration cycle apparatus including the hermetic compressor illustrated in FIG. 1.

A refrigeration cycle apparatus 200 includes a hermetic compressor 100, a suction muffler 101 connected to a suction side of the hermetic compressor 100, a four-way valve 103 connected to a discharge side of the hermetic compressor 100, an outdoor heat exchanger 104, a pressure-reducing unit 105 such as an electric expansion valve, and an indoor heat exchanger 106 that are sequentially connected to each other by refrigerant pipes. In general, in the refrigeration cycle apparatus 200, the indoor heat exchanger 106 is provided in an indoor unit located indoors, and the other units, such as the hermetic compressor 100, the four-way valve 103, the outdoor heat exchanger 104, and the pressure-reducing unit 105 are provided in an outdoor unit located outdoors.

For example, in a heating operation, the four-way valve 103 is connected as indicated by the solid lines in FIG. 3. High-temperature high-pressure refrigerant gas compressed in the hermetic compressor 100 flows into the indoor heat exchanger 106, is condensed to be liquefied, and then is decompressed by the pressure-reducing unit 105 to be low-temperature low-pressure two-phase gas-liquid refrigerant. Then, the two-phase gas-liquid refrigerant flows into the outdoor heat exchanger 104. The two-phase gas-liquid refrigerant that has flowed into the outdoor heat exchanger 104 evaporates to be gasified, and returns to the hermetic compressor 100 again through the four-way valve 103. That is, the refrigerant circulates as indicated by solid arrows in FIG. 3. With this circulation, in the indoor heat exchanger 106 serving as a condenser, indoor air receives heat from the high-temperature high-pressure refrigerant gas and the indoor air is heated, while in the outdoor heat exchanger 104 serving as an evaporator, two-phase gas-liquid refrigerant receives heat from outdoor air.

In a cooling operation, the four-way valve 103 is connected as indicated by broken lines in FIG. 3. High-temperature high-pressure refrigerant gas compressed in the hermetic compressor 100 flows into the outdoor heat exchanger 104, is condensed to be liquefied, and then is decompressed by the pressure-reducing unit 105 to be low-temperature low-pressure two-phase gas-liquid refrigerant. Then, the gas-liquid refrigerant flows into the indoor heat exchanger 106. The two-phase gas-liquid refrigerant that has flowed into the indoor heat exchanger 106 evaporates to be gasified, and returns to the hermetic compressor 100 again through the four-way valve 103. That is, when the heating operation is switched to the cooling operation, the indoor heat exchanger 106 serves as an evaporator, instead of the condenser, and the outdoor heat exchanger 104 serves as a condenser, instead of the evaporator. Thus, refrigerant circulates as indicated by dashed arrows in FIG. 3. With this circulation, in the outdoor heat exchanger 104 serving as the condenser, outdoor air receives heat from the high-temperature high-pressure refrigerant gas, and in the indoor heat exchanger 106 serving as the evaporator, two-phase gas-liquid refrigerant receives heat from indoor air and the indoor air is cooled.

The refrigerant circulating in this refrigeration cycle apparatus is generally one of an R4070 refrigerant, an R410A refrigerant, or an R32 refrigerant.

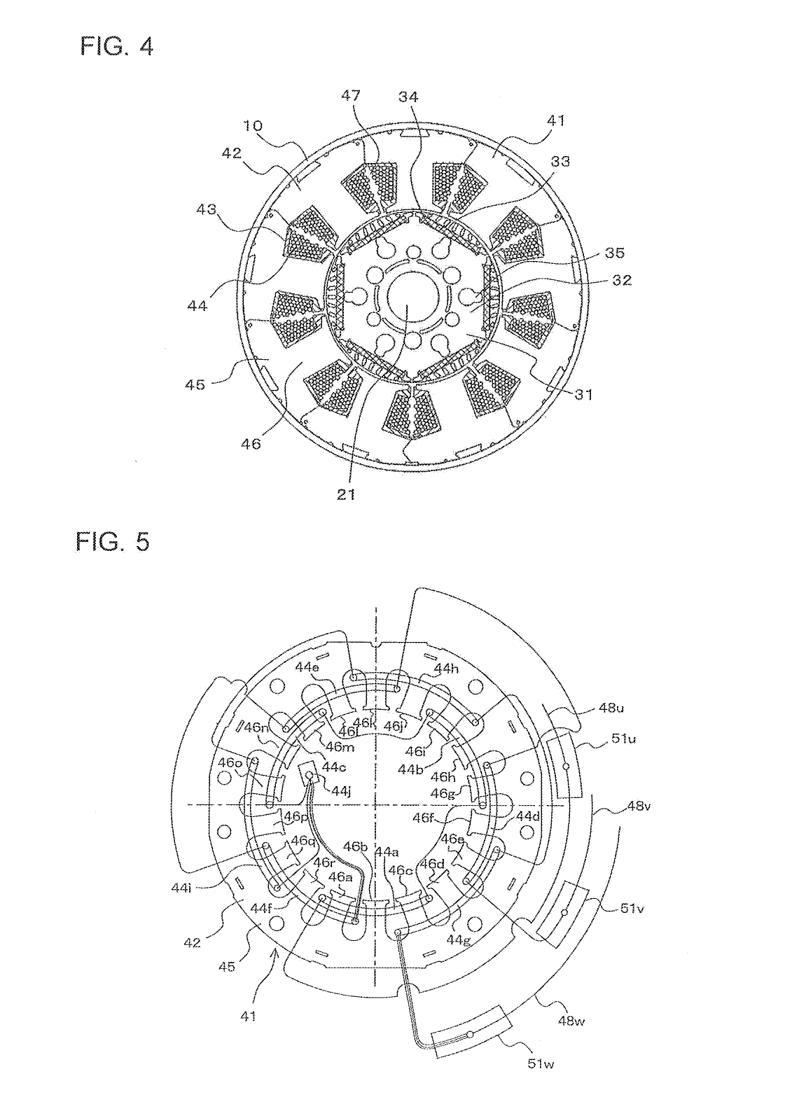

A configuration of the electric motor 30 that transmits a rotation force to the compression mechanism 20 will now be described with reference to FIGS. 1 and 4.

FIG. 4 is a transverse cross-sectional view of an electric motor taken along a line B-B in the hermetic compressor in FIG. 1.

The electric motor 30 includes a substantially cylindrical stator 41 fixed to an inner periphery of the hermetic container 10, and a substantially cylindrical rotor 31 rotatably disposed inside the stator 41.

The rotor 31 includes a rotor core 32 that is a lamination of iron core sheets which is stamped out from flat rolled magnetic steel sheets. The rotor 31 employs a configuration using a permanent magnet such as a brushless DC motor or a configuration using a secondary winding such as an induction motor. For example, in the case of a brushless DC motor as illustrated in FIG. 4, a magnet insertion hole 33 is provided along the axis of the rotor core 32, and a permanent magnet 34 such as a ferrite magnet or a rare-earth magnet is inserted in the magnet insertion hole 33. The permanent magnet 34 forms magnetic poles on the rotor 31. The rotor 31 rotates by action between a magnetic flux generated by the magnetic poles on the rotor 31 and a magnetic flux generated by stator windings 44 on the stator 41.

In the case of an unillustrated induction motor, a secondary winding is provided instead of a permanent magnet for the rotor core 32, and the stator windings 44 of the stator 41 induce the magnetic flux to the secondary winding so that a rotation force is generated, thereby rotating the rotor 31.

A shaft hole through which the rotation shaft 21 passes is formed at a center of the rotor core 32, and the main shaft portion 21a of the rotation shaft 21 is fastened therein by, for example, shrinkage fitting. In this manner, a rotational motion of the rotor 31 is transmitted to the rotation shaft 21. A plurality of air holes 35 are provided around the shaft hole of the rotor core 32. High-pressure high-temperature refrigerant gas compressed in the compression mechanism 20 below the electric motor 30 passes through the air holes 35. The high-pressure high-temperature refrigerant gas compressed in the compression mechanism 20 also passes through an air gap between the rotor 31 and the stator 41 and a gap in the stator windings 44 other than the air holes 35.

The stator 41 includes a stator core 42, an insulating member 43, and the stator windings 44. In a manner similar to the rotor 31, the stator core 42 is a lamination of iron core sheets which is stamped out from flat rolled magnetic steel sheets. An outer diameter of the stator core 42 is larger than an inner diameter of an intermediate portion of the lower container 12, and the stator core 42 is fixed to the inner periphery of the lower container 12 by shrinkage fitting. The stator core 42 includes a back yoke 45 forming an outer cylindrical portion and teeth 46 that are a plurality of magnetic pole teeth projecting from the back yoke 45 toward the center of the stator 41 along the radius of the stator 41, that is, toward the rotor 31, at equal intervals. The teeth 46 are provided with the stator windings 44 to serve as magnetic poles. Slots 47 (space) housing the stator windings 44 are formed between the teeth 46.

As illustrated in FIG. 1, the stator windings 44 are connected to lead wires 48. The lead wires 48 are connected to glass terminals 49 fixed to the hermetic container 10, and are used to supply electric power input to the glass terminals 49 to the stator windings 44. The glass terminals 49 are connected to an external power supply for supplying electric power to the stator windings 44 through the lead wires 48. The external power supply is, for example, an inverter disposed outside the hermetic container 10. The stator windings 44 are groups of windings wound, in an axially direction (vertical direction) of the stator 41, around the teeth 46 of the stator core 42 with the insulating member 43 interposed therebetween, and arranged with almost no space in the slots 47 each between adjacent two of the teeth 46. When current flows in the stator windings 44, the teeth 46 around which the stator windings 44 are wound serve as magnetic poles. The direction of the magnetic poles change in accordance with the direction of current flowing in the stator windings 44.

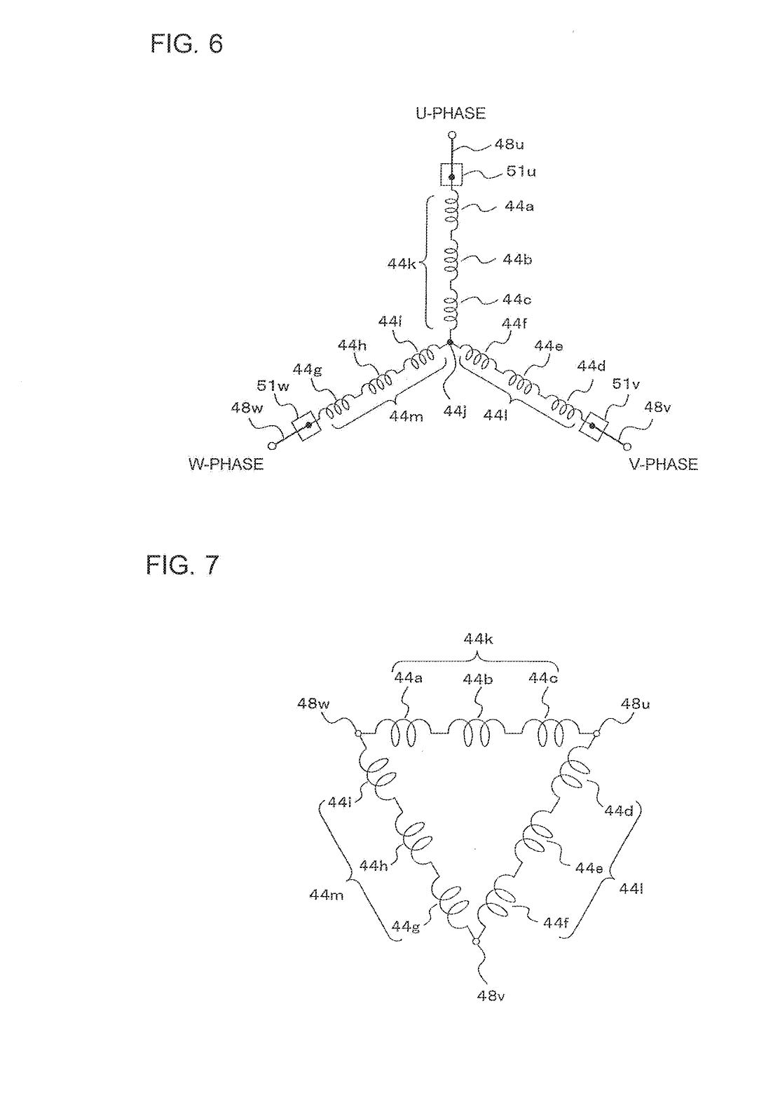

FIG. 5 is a top view schematically illustrating stator windings of the electric motor of the hermetic compressor according to Embodiment 1. FIG. 6 is a connecting diagram of stator windings of the electric motor illustrated in FIG. 5.

The stator 41 illustrated in FIG. 5 is a stator of a three-phase electric motor, and includes, for example, the stator core 42 having 18 teeth 46a to 46r, and a U-phase stator winding 44k, a V-phase stator winding 44l, and a W-phase stator winding 44m that are wound around the teeth 46a to 46r. The U-phase stator winding 44k, the V-phase stator winding 44l, and the W-phase stator winding 44m are three individual groups of windings, and are Y-connected.

As illustrated in FIG. 5, in the U-phase stator winding 44k, a winding 44a wound around the teeth 46a, 46b, and 46c, a winding 44b wound around the teeth 46g, 46h, and 46i, and a winding 44c wound around the teeth 46m, 46n, and 46o are connected in series. The U-phase stator winding 44k has an end connected to a neutral point 44j and the other end connected to a U-phase lead wire 48u through a U-phase terminal 51u, thereby constituting a U-phase of the stator 41.

In the V-phase stator winding 44l, a winding 44d wound around the teeth 46e, 46f, and 46g, a winding 44e wound around the teeth 46k, 46l, and 46m, and a winding 44f wound around the teeth 46q, 46r, and 46a are connected in series. The V-phase stator winding 44l has an end connected to the neutral point 44j and the other end connected to a V-phase lead wire 48v through a V-phase terminal 51v, thereby constituting a V-phase of the stator 41.

In the W-phase stator winding 44m, a winding 44g wound around the teeth 46c, 46d, and 46e, a winding 44h wound around the teeth 46i, 46j, and 46k, and a winding 44i wound around the teeth 46o, 46p, and 46q are connected to in series. The W-phase stator winding 44m has an end connected to the neutral point 44j and the other end connected to a W-phase lead wire 48w through a W-phase terminal 51w, thereby constituting a W-phase of the stator 41.

When current flows through stator windings 44k, 44l, and 44m in the U-phase, V-phase, and W-phase, the stator core 42 is excited and the teeth 46a to 46r serve as magnetic poles. Side surfaces of the slots 47 each formed between adjacent two of the teeth 46 are covered with the insulating member 43 to prevent contact between the teeth 46 and the stator windings 44.

In the electric motor 30 including the thus-configured stator 41, the action between the magnetic flux generated by the stator windings 44 of the stator 41 and the magnetic flux generated by the rotor 31 rotates the rotor 31 and the rotation shaft 21, and the rotation force is transmitted to the compression mechanism 20 through the rotation shaft 21.

The rotation force generated by the electric motor 30, that is, a generated torque, follows the amount of load necessary for suction, compression, and discharge processes of refrigerant gas in the compression mechanism 20. In other words, as the amount of load of the compression mechanism 20 increases, the torque generated by the electric motor 30 needs to be increased. The generated torque of the electric motor 30 is generated by an action between a magnetic flux generated by current flowing in the stator windings 44 and a magnetic flux of a permanent magnet or a secondary winding (in the case of an induction motor) in the rotor 31. The amount of the generated torque is determined based on the amount of the magnetic fluxes generated by the stator 41 and the rotor 31.

In general, the amount of the magnetic flux of the rotor 31 is roughly determined depending on the design of the permanent magnet or the secondary winding in the rotor 31. Among components that determine the amount of the magnetic flux of the stator 41, the number of the stator windings 44 is also determined depending on the design, and thus, the amount of the generated torque of the electric motor 30 is controlled by increasing or decreasing current flowing in the stator windings 44. That is, to increase the generated torque of the electric motor 30, current flowing in the stator windings 44 is increased, whereas to reduce the generated torque, current flowing in the stator windings 44 is reduced.

The current flowing in the stator windings 44 can be controlled by an inverter of an external power supply connected to the lead wire 48 through the glass terminals 49. The inverter can also generate a torque necessary for the electric motor 30 in accordance with the amount of load of the compression mechanism 20. This inverter drives the electric motor 30 by applying alternating currents to the U-phase stator winding 44k, the V-phase stator winding 44l, and the W-phase stator winding 44m of the electric motor 30 with the phase being shifted by 120°.

The stator windings 44 generally uses the copper wire, but may use the aluminum wire in some cases for cost reduction. In the case of using the aluminum wire, however, the lead wire has an electrical resistance about 1.6 times as large as that of the copper wire having the same wire diameter. With the same amount of load of the compression mechanism 20, the same amount of load torque is required, and the same ampere of current flows in the stator windings 44. Thus, even in the case of using the aluminum wire for the stator windings 44, the same ampere of current as that in the case of using the copper wire needs to flow. When a necessary ampere of current flows, a loss of Joule's heat occurring in the stator windings using the aluminum wire increases, as compared to the stator windings using the copper wire. That is, an electric motor using the aluminum wire decreases the efficiency compared to an electric motor using the copper wire.

To suppress efficiency degradation, there is a method using both the copper wire and the aluminum wire. However, since the copper wire and the aluminum wire have electrical resistances that are different from each other by about 1.6 times, if the ratio between the copper wire and the aluminum wire differs among phases, the resistance also differs among the phases, resulting in unbalance among current flowing each phase. The current unbalance causes torque pulsation so that electromagnetic sound occurs to generate noise.

Also in the case of using both the copper wire and the aluminum wire for the stator windings 44, it is difficult to electrically bond these wires. In the case of using the copper wire for the stator windings 44, bonding between the stator windings 44, and bonding between the stator windings 44 and the lead wire 48 are copper bonding, and thus, these windings can be easily performed by, for example, tungsten inert-gas (TIG) welding. On the other hand, in the case of using both the copper wire and the aluminum wire for the stator windings 44, bonding between the stator windings 44, and bonding between the stator windings 44 and the lead wire 48 are bonding between different metals, and these metals have different melting points. Therefore, this case is not suitable for, for example, TIG welding. There are bonding techniques such as ultrasonic wave deposition and frictional pressure contact. These techniques, however, need dedicated special equipment. Thus, from the view point of work efficiency and cost, bonding portions of different metals are preferably reduced as much as possible.

In view of this, in Embodiment 1, among the Y-connected U-phase stator winding 44k, V-phase stator winding 44l, and W-phase stator winding 44m, the aluminum wire is used for the winding 44c, 44f, and 44i that are connected to the neutral point 44j. Specifically, the windings 44a and 44b of the U-phase stator winding 44k, the windings 44d and 44e of the V-phase stator winding 44l, and the windings 44g and 44h of the W-phase stator winding 44m use the copper wire, and the winding 44c of the U-phase stator winding 44k, the winding 44f of the V-phase stator winding 44l, and the winding 44i of the VV-phase stator winding 44m use the aluminum wire.

In the thus-configured stator windings 44, the ratio between the copper wire and the aluminum wire is uniform among the phases, and thus, the phase resistance is uniform among the phases. By uniformizing the interphase resistance among the phases, a balance of current flowing in the phases is obtained. Thus, torque pulsation of the electric motor 30 can be reduced, while reduction of efficiency of the electric motor 30 is suppressed. Therefore, a high-quality, cost-effective, and low-noise electric motor 30 using both the aluminum wire and the copper wire can be provided.

The copper wire is disposed at the sides of the lead wire 48, and the aluminum wire is disposed at the sides of the neutral point 44j. Thus, bonding portions between different metals can be reduced, and manufacturing costs for bonding the different metals can be reduced. As a result, productivity and quality of the electric motor 30 can be enhanced.

In addition, the low-noise electric motor 30 is mounted on the hermetic compressor 100 so that a cost-effective, high-quality hermetic compressor 100 can be provided.

The use of a cost-effective, high-quality hermetic compressor 100 for the refrigeration cycle apparatus 200 enables providing of a highly reliable refrigeration cycle apparatus 20.

### Embodiment 2

In Embodiment 1, among stator windings 44k, 44l, and 44m in the Y-connected U-phase, V-phase, and W-phase, the windings 44c, 44f, and 44i connected to the neutral point 44j are made of the aluminum wire. In Embodiment 2, the aluminum e is used for a part of Δ (delta) -connected stator windings.

FIG. 7 is a connecting diagram of stator windings of an electric motor according to Embodiment 2. The same or like components as those in Embodiment 1 are denoted by the same reference numerals.

In a manner similar to Embodiment 1, a stator 41 of an electric motor 30 according to Embodiment 2 includes a stator core 42 having 18 teeth 46a to 46r and a U-phase stator winding 44k, a V-phase stator winding 44l, and a W-phase stator winding 44m that are wound around the teeth 46a to 46r. The U-phase stator winding 44k, the V-phase stator winding 44l, and the W-phase stator winding 44m are three individual groups of windings, and are Δ-connected.

In the U-phase stator winding 44k, a winding 44a wound around the teeth 46a, 46b, and 46c, a winding 44b wound around the teeth 46g, 46h, and 46i, and a winding 44c wound around the teeth 46m, 46n, and 46o are connected in series. The U-phase stator winding 44k has an end connected to a W-phase lead wire 48w and the other end connected to a U-phase lead wire 48u.

In the V-phase stator winding 44l, a winding 44d wound around the teeth 46e, 46f, and 46g, a winding 44e wound around the teeth 46k, 46l, and 46m, and a winding 44f wound around the teeth 46q, 46r, and 46a are connected in series. The V-phase stator winding 44l has an end connected to a U-phase lead wire 48u and the other end connected to a V-phase lead wire 48v.

In the W-phase stator winding 44m, a winding 44g wound around the teeth 46c, 46d, and 46e, a winding 44h wound around the teeth 46i, 46j, and 46k, and a winding 44i wound around the teeth 46o, 46p, and 46q are connected in series. The W-phase stator winding 44m has an end connected to a V-phase lead wire 48v and the other end connected to a W-phase lead wire 48w.

Among the A-connected U-phase stator winding 44k, V-phase stator winding 44l, and W-phase stator winding 44m, the windings 44b, 44e, and 44h disposed at an intermediate portion in each phase use the aluminum wire. Specifically, the windings 44a and 44c in the U-phase stator winding 44k, the windings 44d and 44f in the V-phase stator winding 44l, and the windings 44g and 44i in the W-phase stator winding 44m use the copper wire, and the winding 44b in the U-phase stator winding 44k, the winding 44e in the V-phase stator winding 44l, and the winding 44h in the W-phase stator winding 44m use the aluminum wire.

In this manner, in the three-phase Δ-connection, the copper wire is disposed to the side of lead wire 48 in each phase, and the aluminum wire is disposed between adjacent ones of the copper wire. Thus, bonding portions between different metals can be reduced, and manufacturing costs for bonding the different metals can be reduced.

In addition, the ratio between the copper wire and the aluminum wire are uniform among the phases, and the phase resistance is uniform among the phases. By uniformizing the phase resistance among the phases, a balance of current flowing in the phases is obtained. Thus, no torque pulsation is generated, and aggravation of electromagnetic sound is prevented, as compared to an electric motor using only the copper wire for the stator windings 44.

### REFERENCE SIGNS LIST

10 hermetic container 11 upper container 12 lower container 20 compression mechanism 21 rotation shaft 21a main shaft portion 21b eccentric shaft portion 21c sub-shaft portion 22 rolling piston 23 cylinder 23a cylinder chamber 23b back-pressure chamber 23c bane groove 24 upper bearing 25 lower bearing 26 bane 27 discharge muffler 30 electric motor 31 rotor 32 rotor core 33 magnet insertion hole 34 permanent magnet 35 air hole 41 stator 42 stator core 43 insulating member 44 stator winding 44a to 44i winding 44j neutral point 44k U-phase stator winding 44l V-phase stator winding 44m W-phase stator winding 45 back yoke 46 teeth 46a to 46r teeth 47 slot 48 lead wire 48u U-phase lead wire 48v V-phase lead wire 48w W-phase lead wire 49 glass terminal 51 terminal 51u U-phase terminal 51v V-phase terminal 51w W-phase terminal 100 hermetic compressor 101 suction muffler 101a connecting pipe for suction 102 discharge pipe 103 four-way valve 104 outdoor heat exchanger 105 pressure-reducing unit 106 indoor heat exchanger 200 refrigeration cycle apparatus

1. An electric motor comprising:
a stator having a cylindrical shape and including a stator core and a stator winding wound around the stator core; and
a rotor rotatably disposed inside the stator,
the stator winding including a plurality of windings connected in series in each phase,
the plurality of windings in each phase being constituted by both copper wire and aluminum wire,
the plurality of windings in the stator winding being connected in a Y-connection,
a winding of the copper wire in each phase being disposed at a power supply line side, and
a winding of the aluminum wire in each phase being disposed at a neutral point side.

2-3. (canceled)

4. A hermetic compressor comprising:
a compression mechanism that compresses refrigerant gas; and
the electric motor of claim 1 that transmits rotation to the compression mechanism so that the refrigerant gas is compressed.

5. A refrigeration cycle apparatus comprising:
the hermetic compressor of claim 4;
an outdoor heat exchanger that serves as a condenser in a cooling operation and serves as an evaporator in a heating operation; and
an indoor heat exchanger that serves as an evaporator in a cooling operation and serves as a condenser in a heating operation.

6. An electric motor comprising:
a stator having a cylindrical shape and including a stator core and a stator winding wound around the stator core; and
a rotor rotatably disposed inside the stator,
the stator winding including a plurality of windings connected in series in each phase,
the plurality of windings in each phase being constituted by both copper wire and aluminum wire,
the plurality of windings in the stator winding being connected in a delta-connection,
windings of the copper wire in each phase being disposed for inter-phase connection,
a winding of the aluminum wire in each phase being disposed between the windings of the copper wire.

7. A hermetic compressor comprising:
a compression mechanism that compresses refrigerant gas; and
the electric motor of claim 6 that transmits rotation to the compression mechanism so that the refrigerant gas is compressed.

8. A refrigeration cycle apparatus comprising:
the hermetic compressor of claim 7;
an outdoor heat exchanger that serves as a condenser in a cooling operation and serves as an evaporator in a heating operation; and
an indoor heat exchanger that serves as an evaporator in a cooling operation and serves as a condenser in a heating operation.
